(19) United States
(12) Patent Application Publication
(10) Pub. No.: US 2006/0128373 A1
(43) Pub. Date: Jun. 15, 2006

(54) Controlling a test instrument from a wireless device under test

(76) Inventors: John Cochrane, Mid Calder (GB); Jamie Allan, South Queensferry (GB)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/299,424

(22) Filed: Dec. 12, 2005

(30) Foreign Application Priority Data
Dec. 15, 2004 (GB) 0427441.1

(51) Int. Cl. H04Q 7/20

(52) U.S. Cl. 455/424; 455/67.11

(57) ABSTRACT

A system and method for testing a wireless device uses a test instrument in communication with the wireless device via an RF link. The test instrument may have a test procedure preloaded therein, which test procedure is transmitted via the RF link to the wireless device so that the test instrument can perform the test procedure on the wireless device, under the control of the wireless device. The test instrument may control the wireless device to the extent necessary to carry out the test procedure.

Foreign priority benefits under 35 U.S.C. 119 for the instant application are hereby claimed to Great Britain application 0427441.1, filed Dec. 15, 2004.

The present invention relates generally to a method and apparatus for the control of a test instrument from a wireless device under test (DUT). Particularly, though not exclusively, it relates to testing of wireless devices, such as mobile phones and Personal Digital Assistants (PDAs), by a test instrument being controlled by the DUT over a wireless RF link.

### BACKGROUND

Recent wireless devices have been developed to incorporate Internet Protocol (IP) or Wireless Application Protocol (WAP) applications and can support the Hypertext Transport Protocol (HTTP) as well as the Transport Control Protocol (TCP/IP) stack. These protocols enable users to connect to the Internet, giving access to services such as email, web-surfing, video-conferencing and video streaming.

Wireless devices now also incorporate technologies that allow third party software applications to be loaded on the wireless DUT. The applications are loaded via an infra-red link, or a data cable from a computer, using interface standards such as USB or RS232 etc. Applications can also be loaded onto a DUT directly from the Internet over an RF link. The most common applications are games, but applications for playing music, editing pictures etc can also be included. These applications can be written in different programming languages depending on the operating system within the wireless DUT and the languages it supports e.g. ‘C’, or Java based languages, such as Java 2 Micro Edition (J2ME).

It is usual that testing of such wireless DUTs be performed over the standard air interface of the mobile device, using normal voice and data channels, such as Packet Data channels for GPRS and circuit switched traffic channels for Global System for Mobile Communication (GSM).

Current test instruments, such as the Agilent Wireless Communication Test Set 8960, are known as ‘one-box’ testers and are programmable. The ‘one-box’ terminology is used because the single instrument includes the functions of a source, a receiver, a simulated base station, and measurements. The ‘one-box’ tester can also take on different personalities in order to provide the simulated base station and measurements peculiar to different phone standards such as GSM, GPRS, CDMA2000 or UMTS.

Such test sets typically have three separate interfaces, the first being the air interface to the wireless device under test (DUT), implementing a proportion of the air protocol (say GPRS or GSM protocol), such that a ‘call’ is established providing a sustained regular RF signal, enabling low-level RF measurements to be made.

The second type of interface is the manual or front panel interface. The instrument is controlled via push buttons mounted on the interface and a menu screen by a human operator.

The third interface on a wireless mobile device tester is normally a control interface to an external PC. Typically most test instruments, when used as part of an automated test solution, are controlled by a wired connection such as USB, IEEE-488 or LAN. An external computer sends commands via the wired connection to control the test instrument. The LAN interface may also be used to connect the test instrument to the internet, allowing the wireless DUT to download files and web-surf as it would in ‘real life’.

The present invention serves to mitigates the problems of the prior art by providing a method and apparatus for the control of a test instrument from a wireless DUT over a wireless RF link.

### BRIEF SUMMARY

Thus, according to a first aspect, the invention provides an apparatus for testing wireless devices via an RF link, the apparatus comprising an RF interface including an RF transceiver for transmitting and receiving messages from a wireless device under test via the RF link, a processor coupled to the RF interface and a memory for storing at least part of a test procedure for the particular device under test, wherein the processor can generate commands to be sent in the messages over the RF link to the wireless device and can receive commands generated by the wireless device for controlling the processor, whereby the test procedure can be controlled, at least partly, by the wireless device under test.

According to a second aspect, the invention provides a wireless device, comprising an RF interface including an RF transceiver for transmitting and receiving messages from a test apparatus via the RF link, a processor coupled to the RF interface and a memory for storing at least part of a test procedure for the particular wireless device, wherein the processor can generate commands to be sent in the messages over the RF link to the test apparatus and can receive commands generated by the test apparatus for controlling the processor, whereby the test procedure can be controlled, at least partly, by the wireless device.

In one embodiment, the test procedure is provided in the memory during manufacture of the apparatus or device. Alternatively, the test procedure may be downloaded over the RF interface.

The apparatus may further comprise a wired interface, which may be used for downloading the test procedure. The wired interface may be one of USB, RS-232 or LAN.

In a third aspect, the invention provides a system comprising a wireless device as described above and an apparatus for testing wireless devices as described above, wherein the processor of the wireless device generates commands to be sent in the messages over the RF link for controlling the processor of the apparatus for controlling at least part of the test procedure.

The test procedure may conveniently be downloaded by the wireless device from the apparatus and stored in the memory of the wireless device.

The processor of the apparatus may generate commands to be sent in the messages over the RF link for controlling the processor of the wireless device for controlling part of the test procedure.

In a fourth aspect, the invention provides a method for testing a wireless device from a test instrument over an RF interface, where the wireless device at least partly controls the test instrument, the method comprising loading a test procedure into the test instrument, loading the test procedure into the wireless device, transmitting messages including commands for controlling the test instrument from the wireless device to the test instrument, the test instrument extracting the commands from the messages and transmitting messages containing commands for controlling the wireless device back to the wireless device, the wireless device extracting the commands from the messages, and the test procedure being carried out on the wireless device, by the test instrument, at least partly under the control of the wireless device.

Loading the test procedure into the wireless device may comprise transmitting the test procedure from the test instrument.

### BRIEF DESCRIPTION OF THE DRAWINGS

One embodiment of the invention will now be more fully described, by way of example, with reference to the drawings, of which:

FIG. 1 shows an overview of a current wireless device testing architecture;

FIG. 2 shows a schematic block diagram of an instrument control architecture;

FIG. 3 shows an overview of an instrument control architecture, according to one embodiment of the present invention;

FIG. 4 shows a schematic diagram of an instrument control architecture, according to one embodiment of the present invention;

FIG. 5 shows a diagram of the architecture of a custom application, according to one embodiment of the present invention;

FIG. 6 shows a message sequence chart illustrating an exemplary sequence of instructions for a measurement request from a DUT according to one embodiment of the present invention;

FIG. 7 shows a message sequence chart illustrating an exemplary sequence of instructions for a setting request from a DUT according to one embodiment of the present invention;

FIG. 8 shows a message sequence chart illustrating an exemplary sequence of instructions for a request from a test instrument according to one embodiment of the present invention.

### DETAILED DESCRIPTION

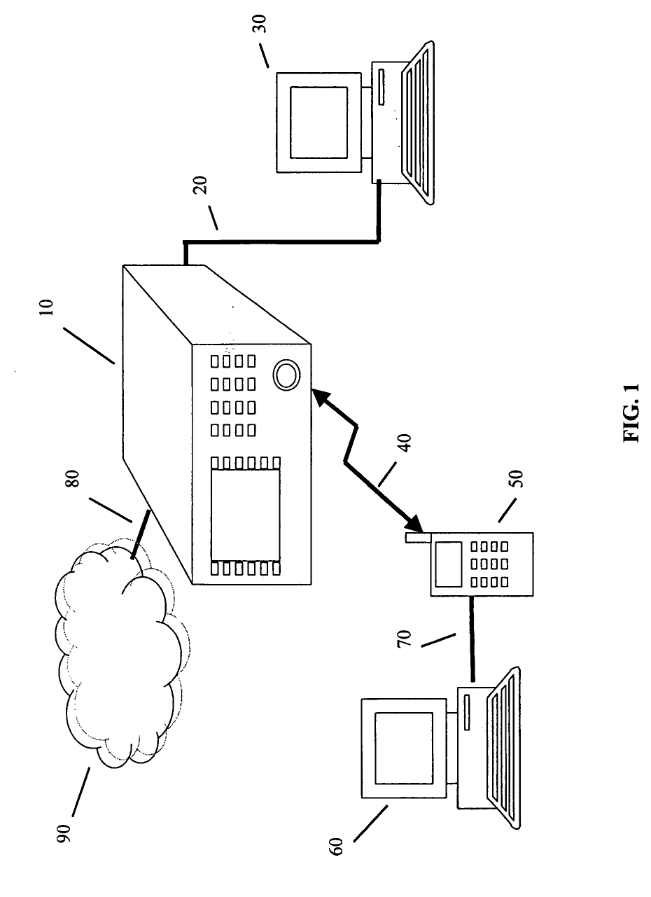

In a brief overview of how current wireless device testing is performed, there is shown in FIG. 1 an overview of a current wireless device testing architecture, comprising a test instrument 10, such as the Agilent 8960 for testing wireless devices e.g. PDAs or Mobile Phones, which is connected via a wired connection 20 e.g. GPIB, USB, LAN, to a PC 30 which has loaded onto it test instrument control software. The PC 30 controls the test instrument 10 to make test settings and take test measurements. The test instrument 10 can also be controlled via human interaction with the externally mounted keypad and menu screen.

A wireless DUT 50 is connected to the test instrument 10 via an RF link 40 with sufficient bandwidth and the correct protocols to support and sustain the link. The testing of the wireless DUT 50 is driven using an external controlling source 60 e.g. human interaction, robotics, external PC software etc. If the external controlling source is a PC 60, then the connection is a wired connection 70 as previously described.

The test instrument 10 also has a connection to the Internet, or a simulated Internet 90 via a LAN interface 80, such as 10/100baseT NIC. This connection allows the wireless DUT 50 to perform functions such as email download and web-surfing via the test instrument 10.

The RF link 40 is usually wireless, but in a test environment the RF signal can be transmitted by cable to prevent cross interference to other co-located test apparatus. It will be appreciated that the use of the term “wireless” herein includes such a cable-transmitted RF link.

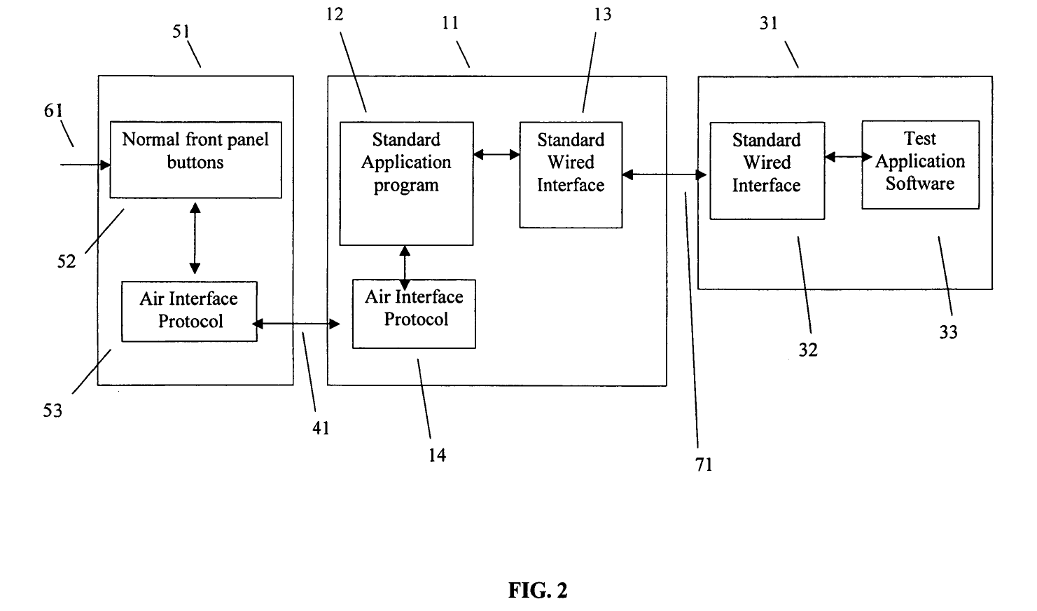

FIG. 2 shows an overview of a test instrument control architecture, in which a DUT 51 is connected over a wireless RF link 41 using an air interface protocol such as GPRS to a test instrument 11. The test instrument 11 has an embedded application program 12 running, which uses its air interface protocol 14 to establish RF links with the DUT 51.

The DUT 51 is controlled during the test via an external source 61 such as a PC or human interaction. If human interaction is used then normal front panel buttons 52 on the DUT 51 are used such as “call” and “call end”.

The test instrument 11 is connected to an external control PC 31 via a standard wired interface 13, 71, 32 such as USB, GPIB, LAN, RS-232 etc. Test application software 33 running on the PC 31 controls the test instrument 11 during the running of the test.

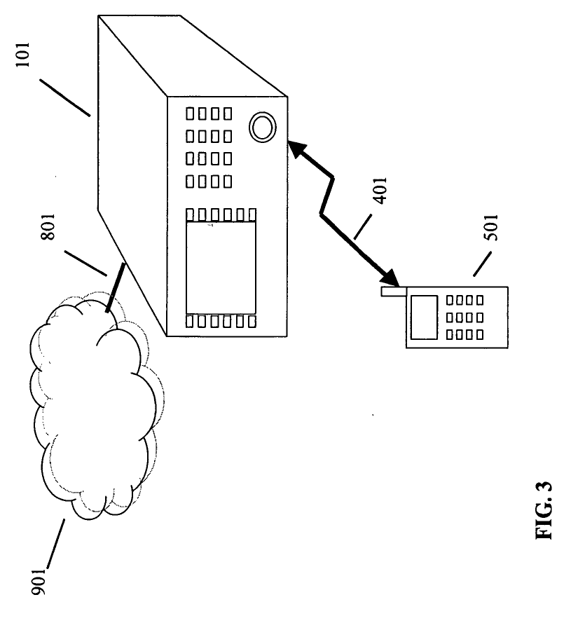

FIG. 3 shows an overview of a wireless device testing architecture according to one embodiment of the present invention. A wireless DUT 501 has loaded into it a software application which sends test instrument control messages over the air, instructing a test instrument 101 to make settings and take measurements.

The test instrument 101 is modified to extract instrument control commands from wireless DUT messages and is connected to the wireless DUT 501 via a wireless RF link 401. The wireless RF link 401 has a protocol operating over it capable of sending custom messages between the wireless DUT 501 and the test instrument 101.

The test instrument 101 also has a connection to the Internet, or a simulated Internet 901 via a LAN interface 801, such as 10/100baseT NIC. This connection allows the wireless DUT 501 to perform functions such as email download and web-surfing via the test instrument 101.

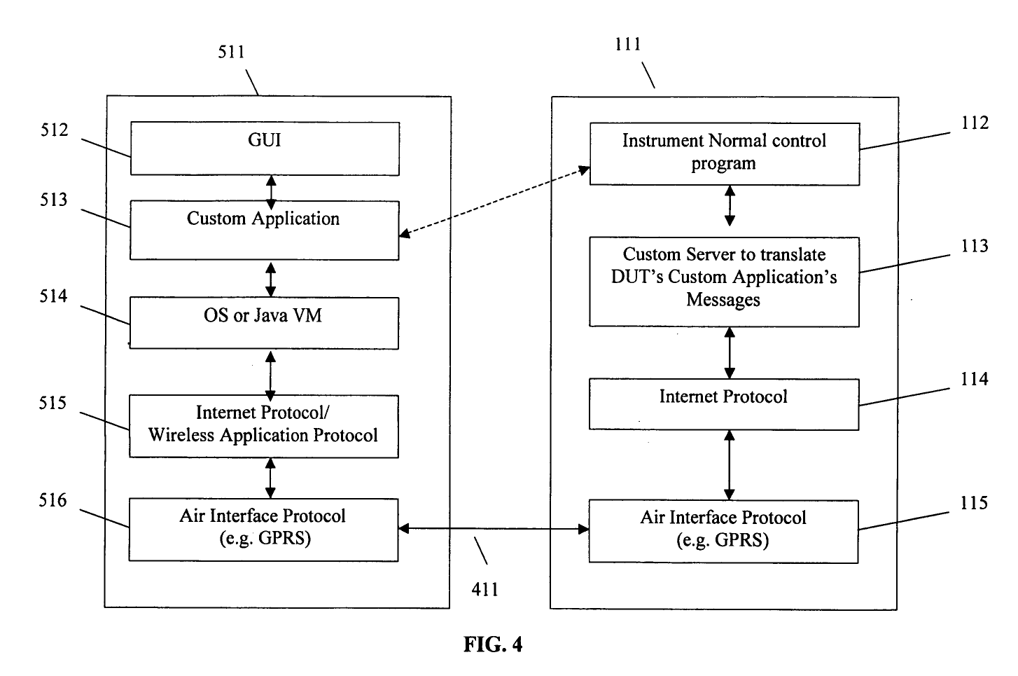

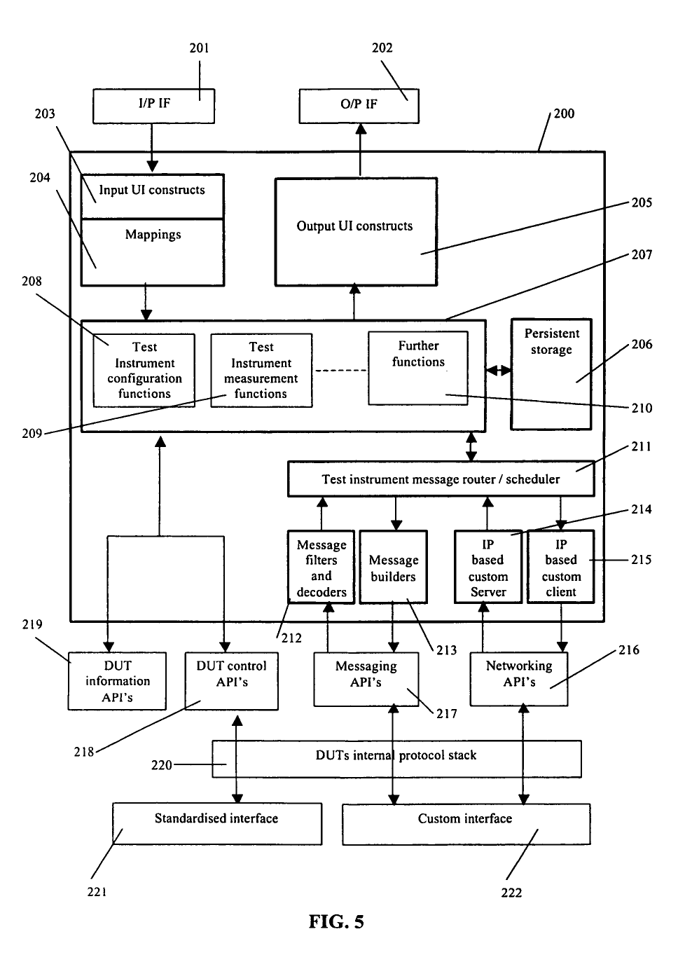

The custom application, protocol and custom messages are described in further detail below with reference to FIGS. 4 and 5.

FIG. 4 shows a custom application 513 which is loaded onto a wireless DUT 511 and which is able to start measurements running on the test instrument 111 and is able to query the results and display them on the device's graphical user interface (GUI) 512.

The custom application 513 can either be loaded onto the wireless DUT 511 at the time of its manufacture, downloaded over the wireless RF link 411 from the test Instrument 111 (or from a LAN connected to the test instrument), or can be supplied as files and downloaded via a direct connection (e.g. USB, infra-red, RS232) to then be installed on the wireless DUT 511. In the case of downloads from or via the test instrument, normal data channels for a particular technology are used e.g. Packet Data Traffic Channels for GPRS, or circuit switched data traffic channels for GSM.

In this particular embodiment the custom application 513 is written using the J2ME language and runs on the normal operating system (OS) 514 of the wireless DUT 511. The application provides a GUI 512 (menus, selections, results display). The wireless DUT 511, by use of the custom application 513, can send defined commands to the test instrument 111, such as setting instrument specific parameters, starting measurements and receive and display the responses via the GUI. For example, a wireless DUT that supports GPRS can have an associated application that allows the setting of instrument specific GPRS parameters such as: coding schemes used, number of timeslots used and power levels etc. The wireless device is also able to start GPRS measurements running on the test instrument and to query results and display them via its GUI.

Inside the test instrument 111, its standard software 112 is modified to capture the commands coming from the custom application 513 running on the wireless DUT 511. These commands arrive at the test instrument's HTTP server 113, are parsed, and either translated into the normal instrument control commands or routed internally as appropriate. HTTP is only one of several transport protocols that could be used to communicate between the DUT and the test instrument. A custom TCP socket server, or even a non-IP based mechanism such as SMS messaging, could be used instead.

The custom application 513 resident on the wireless DUT 511 uses the device's available air interface protocols 516, 411, to send the commands to the test instrument 111. In the case of a J2ME application, the commands may be sent using HTTP via Universal Resource Locator (URL) requests of the following format:

$$http : // {\underbrace{156.141 .111 .64}}_{A} / {\underbrace{command}}_{B} / {\underbrace{?}}_{C} {\underbrace{307}}_{D} {\underbrace{\& count = 99 \& value = 1}}_{E}$$

where A is the IP address of the test instrument being controlled and B, under normal HTTP operation, is a path to a directory on the test instrument's HTTP server 113 where the requested document can be found. In this embodiment, this allows the test instrument's HTTP server 113 to recognize the request is a ‘command’ from a wireless DUT 511 and handle it appropriately rather than trying to serve a file. C is a command separator: everything after this contains specific information about the command and its parameters. D is the command's unique ID number. E refers to any parameters required for the command, separated by ‘&’ characters. Parameters take the form of ‘label=value’. The number of parameters is variable and dependent upon the command being sent. D & E form the specific test instrument 111 instructions.

After the test instrument 111 has finished handling a received command, the HTTP server 113 responds to the custom application 513 on the wireless DUT 511 as it would to any ‘normal’ request it received, simply by returning a file. The file returned however, is a dynamically created text file containing a status code and any relevant further information, formatted similarly to D+E above.

The custom application 513 on the wireless DUT 511 parses the returned file upon receipt and proceeds appropriately based on the contents. This may result, for example, in control being returned to the operator, an explanatory error message being displayed or some further communication between the test instrument 111 and the custom application 513 taking place.

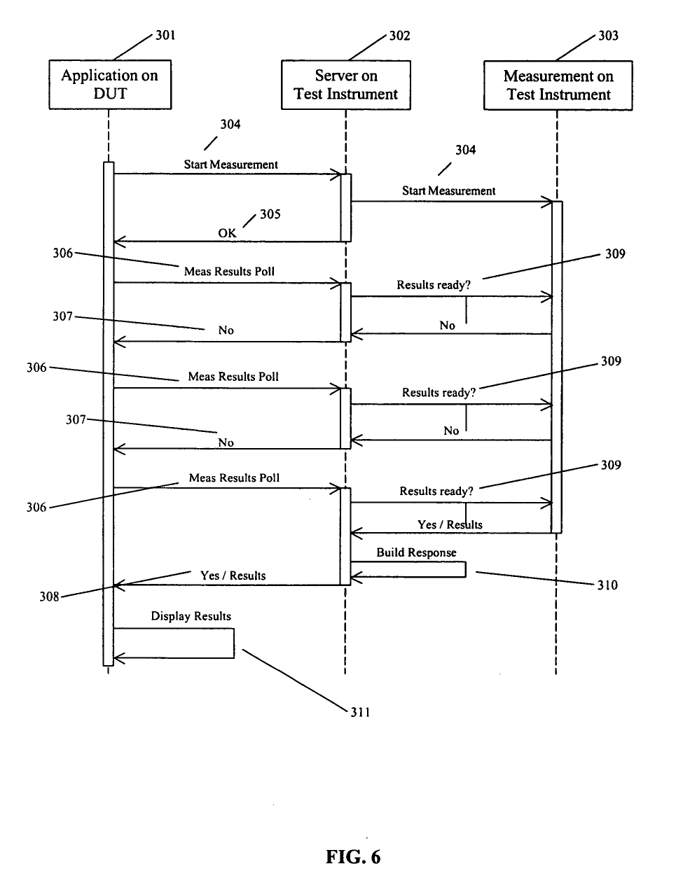

The architecture of the custom application is described in more detail below with reference to FIG. 5. Message Sequences between the test instrument and the DUT will be described further below with reference to message sequence charts as shown in FIGS. 6, 7 and 8.

Thus, FIG. 5 illustrates a diagram of the architecture of a custom application 200 according to one embodiment of the present invention. The custom application 200 uses an input interface 201 e.g. a keypad or display. These inputs are handled by input UI constructs 203 (UI meaning User Interface), which use a mapping function 204 to relate user inputs such as key presses to internal sub-functions 207. Within the custom application 200, the sub-functions 207, such as test instrument configuration functions 208, test instrument measurement functions 209 and further functions 210, such as DUT throughput tester, power vs. battery drain tester etc all use persistent storage 206 for storing results history, configuration settings etc (e.g. a J2ME RecordStore).

The sub-functions 207 may use a test instrument router/scheduler 211 to communicate with the test instrument. The router/scheduler handles the timing and routing of messages passed between the sub-functions 207 and the test instrument to allow multiple sub-functions to run concurrently within the wireless DUT and ensure that messages passed to/from the test instrument are associated with the relevant sub-function. The test instrument router/scheduler 211 may communicate with the test instrument using a variety of protocols. Standardised messaging protocols (such as SMS/MMS) may be used in which case the router/scheduler 211 utilises message filters and decoders 212 and message builders 213 to decode and construct custom messages from/to the test instrument respectively. Alternatively, an IP based custom server 214 and an IP based custom client may instead be used to perform similar functions for passing messages using a custom IP based protocol.

The sub-functions 207 within the custom application 200 can be initiated from either the DUT input interface 201 or in response to commands arriving from the test instrument. They may behave differently depending on where they originated (e.g. results of a sub function may be displayed on the DUT screen or returned to the test instrument).

The sub-functions use output UI constructs 205, such as progress bars, display screens etc, to display results on the output interface 202. The output UI constructs 205 can be implemented in graphics primitives or portable high level graphics constructs provided by the programming environment, or operating system. The output interface 202 on the DUT could be a speaker or display.

APIs (Application Program Interfaces) 219, 218, 217 and 216 are provided for DUT control and information query and may be provided by the native OS or programming language on the DUT or may be manufacturer specific. The APIs perform different functions, such as: querying DUT information 219, which may be used to query, for example battery power, DUT ID etc; DUT control 218 e.g. initiating receipt of voice calls; starting data connections etc; messaging 217 for SMS, MMS, and Bluetooth support; and networking 26 for TCP/IP/HTTP support. Most APIs utilise the DUT's internal protocol stack 220, such as GSM/GPRS or WCDMA, to perform their designated functions. Communication can then take place with the Test instrument over a standardised interface 221 over an RF link (e.g. to start/end voice calls or perform other standardised functions) or over a custom interface 222 where custom messages to/from the test instrument are sent using a higher layer protocol via the RF link (e.g. IP or SMS).

Sub-functions 207 could be thought of as ‘mini applications within the application’ and can be run concurrently.

FIG. 6 shows a message sequence chart illustrating an exemplary sequence of commands for a measurement request from a DUT, according to one embodiment of the present invention.

The commands illustrate the sequence of events that may occur when initiating a measurement on the test instrument 303, via an application on the DUT 301. The server on the test instrument 302 handles the requests from the application on the DUT 301 to perform the measurement on the test instrument 303.

A start measurement command 304 is sent from the application on the DUT 301 to the server on the test instrument 302; this is then forwarded to the function performing the measurement on the test instrument 303. An OK acknowledgement 305 is sent back from the server on the test instrument 302 to the application on the DUT 301 to acknowledge the measurement was started. Alternatively a “not OK” message could be sent at this point if the test instrument was unable to process the request for any reason.

Measurements need activity on the RF link to allow them to have something to measure. For packet switched connections this leads to a requirement to keep data transferring over the RF link to ensure the DUT is transmitting/receiving and measurements can complete in the test instrument.

In this example, the Meas Results Poll messages 306 from the application on the DUT 301 to the server on the test instrument 302 are the primary means of keeping data flowing in both directions over the RF link. For increased measurement speed it may be more appropriate to use a dedicated larger data transfer utilising a custom socket connection or something similar.

The server on the test instrument 302 polls the measurement to see if results are ready 309 and when they are, it builds a Response 310 and then sends the Results 308 back to the application on the DUT 301. The application on the DUT 301 then displays the results 311. If the results are not ready then a NO response message 307 is sent from the server on the test instrument 302 to the application on the DUT 301.

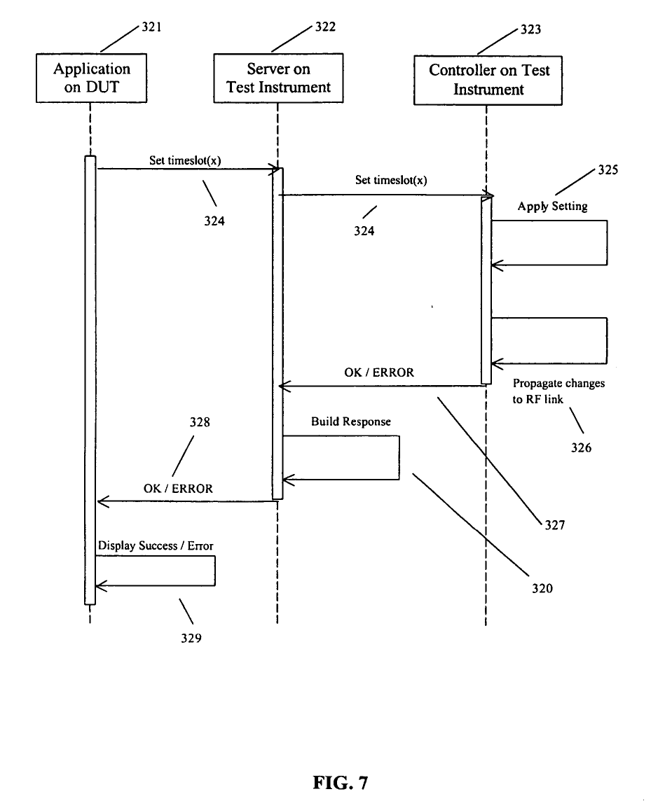

FIG. 7 shows a message sequence chart illustrating an exemplary sequence of commands for a setting request from a DUT according to one embodiment of the present invention. The chart outlines the sequence of events that may occur when requesting a configuration change in the test instrument via a command from the DUT.

A set timeslot (x) message 324 is sent from the application on the DUT 321 to the server on the test instrument 322. This is then forwarded from the server on the test instrument 322 to the controller on the test instrument 323. The setting is applied on the test instrument (Apply Setting 325). Changes are then propagated to the RF link (Propagate changes to the RF link 326). An OK or error response 327 is sent from the controller on the test instrument 323 to the server on the test instrument 322. A response is then built on the server (Build Response 320) and then the results of the configuration change, Ok/Error 328, are communicated back to the application on the DUT 321. A display of the configuration change (Display Success/Error 329) is made by the application on the DUT 321.

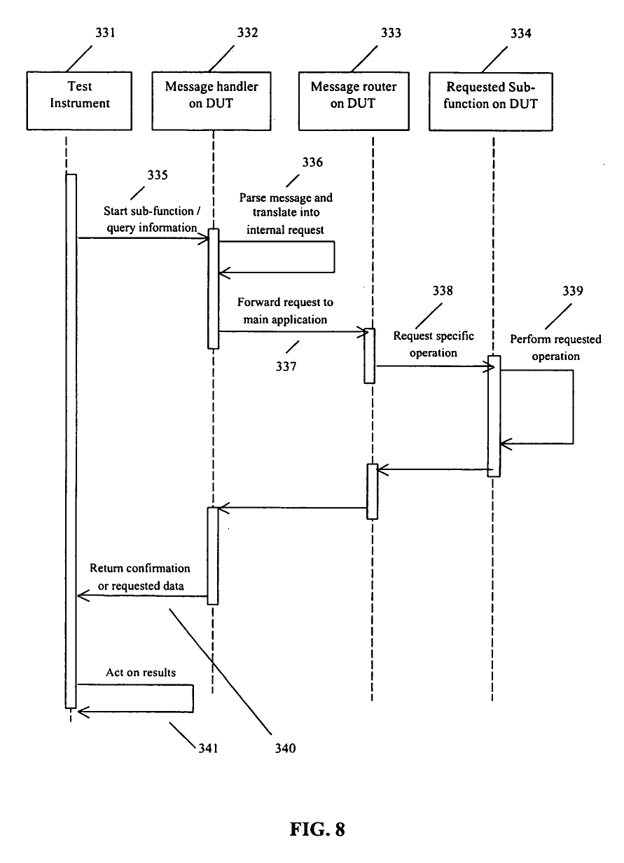

FIG. 8 shows a message sequence chart illustrating an exemplary sequence of commands for a request from a test instrument according to one embodiment of the present invention. The chart outlines the sequence of events that may occur when the test instrument requests, via the custom interface on the RF link, a particular service to be performed by the DUT.

A start sub-function/query information message 335 is sent from the test instrument 331 to the message handler within the custom application on the DUT 332, this is then parsed and then translated into an internal request (parse message and translate into internal request 336). The request is forwarded from the message handler on the DUT 332 to the requested sub-function on the DUT 334 via the message router on the DUT 333, with use of the forward request to main application 337 and request specific operation 338 commands. The requested sub-function in the application on the DUT then performs the requested operation (perform requested operation 339) and then a confirmation or requested data is returned to the test instrument 331 (return confirmation or requested data 340).

The test instrument 331 then acts on the results 341.

Having the communication between the wireless DUT and the test instrument at the application level facilitates measurements/observations being taken from the DUT's perspective.

It is envisaged that the wireless DUT's test program is resident/running within the DUT, controlling (appropriately modified) external test instruments, for example taking RF measurements on the external instrument and displaying them on the DUT.

It is also envisaged that the architecture could also be used to provide test/observation paths previously inaccessible to current test instruments. One embodiment of the invention provides the ability to report the rate at which data (TCP/IP or UDP packets) is being sent to the wireless DUT, as observed from the sender's perspective. An embodiment of the invention provides the possibility of reporting the rate at which the data is received by the DUT and returning the value to the test instrument so that both the sender's and receiver's perspectives could be displayed/compared.

Thus, the described embodiment provides peer to peer communication over an RF link between a wireless DUT and a test instrument and the method of achieving it. The particular example given is of the application in the wireless DUT controlling the test instrument. It is equally expected that this peer-to-peer communication could be used for the test equipment application to control the wireless DUT such as but not limited to performing functions that previously required a manual intervention, or a manufacturer's proprietary interface e.g. make a call, answer a call.

It will be appreciated that although only one particular embodiment of the invention has been described in detail, various modifications and improvements can be made by a person skilled in the art without departing from the scope of the present invention. For example, the test program for the particular DUT may be initially stored solely in the DUT. It is envisaged, therefore, that the test instrument may be generic to many different types or makes of wireless device, which, when they need testing, control the test instrument to the extent necessary to perform the test, with the test instrument partly controlling the wireless device to enable the particular test procedures to be carried out.

1. An apparatus for testing wireless devices via an RF link, the apparatus comprising an RF interface comprising an RF transceiver for transmitting and receiving messages from a wireless device under test via the RF link, a processor coupled to the RF interface and a memory for storing at least part of a test procedure for the wireless device under test, wherein the processor is operable to generate commands to be sent in the messages over the RF link to the wireless device and receive commands generated by the wireless device for controlling the processor, whereby the test procedure can be controlled, at least partly, by the wireless device under test.

2. The apparatus according to claim 1, wherein the test procedure is provided in the memory during manufacture of the apparatus.

3. The apparatus according to claim 1, wherein the test procedure is downloaded over the RF interface.

4. The apparatus according to claim 1, further comprising a wired interface.

5. The apparatus according to claim 4, wherein the test procedure is downloaded over the wired interface.

6. The apparatus according to claim 5, wherein the wired interface is one of USB, RS-232 or LAN.

7. A wireless device, comprising an RF interface including an RF transceiver for transmitting and receiving messages from a test apparatus via the RF link, a processor coupled to the RF interface and a memory for storing at least part of a test procedure for the particular wireless device, wherein the processor is operable to generate commands to be sent in the messages over the RF link to the test apparatus and receive commands generated by the test apparatus for controlling the processor, whereby the test procedure is controlled, at least partly, by the wireless device.

8. The device according to claim 7, wherein the test procedure is provided in the memory during manufacture of the device.

9. The device according to claim 7, wherein the test procedure is downloaded over the RF interface.

10. A system comprising a wireless device according to claim 7 and an apparatus for testing wireless devices via an RF link, the apparatus comprising an RF interface including an RF transceiver for transmitting and receiving messages from a wireless device under test via the RF link, a processor coupled to the RF interface and a memory for storing at least part of a test procedure for the particular device under test, the processor being able to generate commands to be sent in the messages over the RF link to the wireless device and to receive commands generated by the wireless device for controlling the processor, whereby the test procedure can be controlled, at least partly, by the wireless device under test, wherein the processor of the wireless device generates commands to be sent in the messages over the RF link for controlling the processor of the apparatus for controlling at least part of the test procedure.

11. A system according to claim 10, wherein the test procedure is downloaded by the wireless device from the apparatus and stored in the memory of the wireless device.

12. A system according to claim 10, wherein the processor of the apparatus generates commands to be sent in the messages over the RF link for controlling the processor of the wireless device for controlling part of the test procedure.

13. A method for testing a wireless device from a test instrument over an RF interface, where the wireless device at least partly controls the test instrument, comprising:
loading a test procedure into the test instrument;
loading the test procedure into the wireless device;
transmitting messages including commands for controlling the test instrument from the wireless device to the test instrument;
the test instrument extracting the commands from the messages and transmitting messages containing commands for controlling the wireless device back to the wireless device;
the wireless device extracting the commands from the messages; and
the test procedure being carried out on the wireless device, by the test instrument, at least partly under the control of the wireless device.

14. The method according to claim 13, wherein loading the test procedure into the wireless device comprises transmitting the test procedure from the test instrument.

15. The method according to claim 13, wherein the test procedure is loaded into the wireless device during manufacture of the device.

16. The method according to claim 13, wherein the test procedure is loaded into the wireless device over an RF interface.

17. The method according to claim 13, wherein the test procedure is loaded into the wireless device over a wired interface.

18. The method according to claim 17, wherein the wired interface is one of USB, RS-232 or LAN.
